(19) United States
(12) Patent Application Publication
(10) Pub. No.: US 2004/0215816 A1
(43) Pub. Date: Oct. 28, 2004

(54) Apparatus and methods for communication among devices

(76) Inventors: Stephen T. Hayes, North Granby, CT (US); Michael J. Ingson, Fairfax, VA (US); Alfred F. Pandolfi, Potomac Falls, VA (US)

Correspondence Address: BIRCH STEWART KOLASCH & BIRCH, PO BOX 747, FALLS CHURCH, VA, 22040-0747, US

(21) Appl. No.: 10/736,075

(22) Filed: Dec. 16, 2003

Related U.S. Application Data
(60) Provisional application No. 60/433,608, filed on Dec. 16, 2002.
(60) Provisional application No. 60/433,593, filed on Dec. 16, 2002.

(51) Int. Cl. G06F 15/173

(52) U.S. Cl. 709/238

(57) ABSTRACT

The present invention relates generally to methods and apparatus use of proximity detection and its use within automation system software to automatically modify or adjust the system software as the user changes locations within the home or business. Additionally, the present invention relates generally to the use of one control device to control various other devices within a home and/or business environment.

### RELATED APPLICATIONS

This application is related to and claims priority to U.S. Provisional Application No. 60/433,608, filed Dec. 16, 2002, entitled “Apparatus and Method For Routing User Commands to a Controlled Device”, and to U.S. Provisional Application No. 60/433,593, filed on Dec. 16, 2002, entitled “Method and Apparatus For Automatically Modifying or Adjusting Automation System Software as a user Changed Locations”, which are expressly incorporated herein by reference in their entirety.

### BACKGROUND OF THE INVENTION

1. Field of the Invention

Principles consistent with embodiments of the present invention relate generally to home and business automation and, more specifically, relate to the use of proximity detection and its use within automation system software to automatically modify or adjust the system software as the user changes locations within the home or business. Further principles consistent with embodiments of the present invention relates generally to the use of one control device to control various other devices within a home and/or business environment.

2. Description of Related Art

With the increase of technology within the home and business environments, consumers of automation software have an increasing number of devices that can now be remotely controlled individually. These devices cover a wide range of control including, but not limited to, lights, thermostat control, home entertainment control such as televisions, DVD players, audio equipment, etc., security systems, sprinkler systems, and computer systems.

Also available to the consumer are an increasing number of smart devices such as personal computers, and personal digital assistants (PDA's) that can be used to control these devices. Newer wireless technologies such as 802.11, Bluetooth®, and others allow the consumer to take these smart devices with them as they navigate the home or business environment. Using these smart devices as platforms to run automation system software allows the consumer to have, at their fingertips, complete control of the home or business environment.

As the number of controllable devices increases, it becomes more and more difficult for the user to have fast access within the automation software to all of the devices that are available. Well-developed software may ease this issue by allowing users to manage their interaction to some degree, but still requires extensive user navigation as the user changes environments, i.e., changing rooms. One example of this problem would be a user screen within the automation software with a button to turn on or off the lights. As the user moves around the home or business premises, the desired set of lights to control will change. In today's automation systems, this would require the user to navigate to another set of buttons to control the lights.

As such, there is a need for an apparatus and method that allows a user to automatically alter or adjust home and/or business automation software based on the user's location within the environment. Additionally, there is a need for an apparatus and method that allows a user to control a variety of devices with one control apparatus.

There are also a growing number of ‘Smart Devices’ available or already existing within the home or business environment such as Personal Computers, PDA's, Universal remotes, etc. Each of these smart devices provides interactive user control and within the home or business environment provides a limited capability to control some, but not all of the above mentioned control devices. As an example, a Personal Computer may have an X10 controller attached that allows it to control the lights, but due to its location cannot effectively control the TV in another room by IR commands. Or a PDA may have software that allows the infrared data association (IRDA) port to control consumer infrared (IR) devices such as your television, but has no X10 controller to control the lights. Furthermore, each of these smart devices typically has some form of communication ability such as Internet protocol (IP), Bluetooth™, IR, Serial, etc.

With the above-mentioned devices, the consumer can control all aspects of the home or business environment, but this requires the use of several smart devices, one to control each type of controlled device. This creates an undesirable situation for the consumer, forcing them to either carry with them the proper smart devices to control each controlled device, or to physically move to the smart device required for control. In many cases it is impossible to carry the smart device since it may be hardwired to a specific location and having to go to the smart device can be time consuming and defeats the purpose of the automation system to some degree.

As such, there is a need to allow the consumer to effectively control all controlled devices from any smart device irrespective of the smart device that specifically controls the device.

### BRIEF DESCRIPTION OF THE DRAWINGS

The accompanying drawings, which are incorporated in and constitute a part of this specification, illustrate embodiments of the invention and, together with the description, explain the principles of the invention. In the drawings:

FIG. 1 depicts an exemplary system environment for implementing features consistent with principles of embodiments of the present invention;

FIG. 2 depicts an exemplary block diagram of an echo device consistent with the principles of embodiments of the present invention;

FIG. 2A depicts an exemplary block diagram of a personal computer consistent with the principles of embodiments of the present invention;

FIG. 3 depicts an exemplary screen display presented to a user for selecting a remote control template consistent with the principles of embodiments of the present invention;

FIG. 3A depicts an exemplary screen display presented to a user for selecting a remote control template consistent with the principles of embodiments of the present invention;

FIG. 4 depicts exemplary screen displays presented to a user for creating a custom remote control template consistent with the principles of embodiments of the present invention;

FIG. 4A depicts an exemplary user input screen display presented to a user for creating a custom remote controls consistent with the principles of embodiments of the present invention;

FIG. 4B depicts an exemplary user input screen display presented to a user for creating macros consistent with the principles of embodiments of the present invention;

FIG. 5 depicts an exemplary screen display presented to a user for selecting actions to occur when a certain event is triggered, consistent with the principles of embodiments of the present invention;

FIG. 6 depicts an exemplary screen display presented to a user for selecting a device to remotely control consistent with the principles of embodiments of the present invention;

FIG. 7 depicts an exemplary screen display presented to a user for remotely controlling a VCR consistent with the principles of embodiments of the present invention;

FIG. 8 depicts an exemplary system environment indicating exemplary data flow consistent with the principles of embodiments of the present invention;

FIG. 9 depicts an exemplary flow diagram of the steps performed by a controller consistent with the principles of embodiments of the present invention;

FIG. 10 depicts an exemplary flow diagram of the steps performed by an echo device consistent with the principles of embodiments of the present invention; and

FIG. 11 depicts an exemplary flow diagram of the steps performed by a controller consistent with the principles of embodiments of the present invention.

### DETAILED DESCRIPTION

Reference will now be made in detail to the features of the principles of embodiments of the present invention, examples of which are illustrated in the accompanying drawings. Wherever possible, the same reference numbers will be used throughout the drawings to refer to the same or like parts.

Principles consistent with embodiments of the present invention relates generally to the use of proximity detection and its use within automation system software to automatically modify or adjust the system software as the user changes locations within the home or business. Further principles consistent with embodiments of the present invention relates generally to the use of one control device to control various other devices within a home and/or business environment.

System Architecture

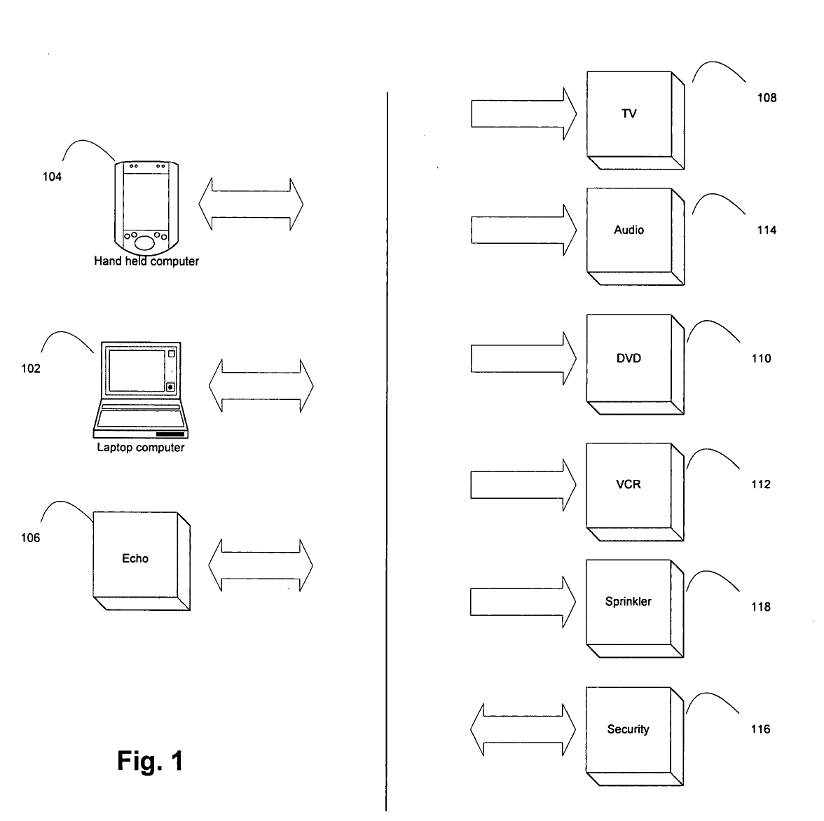

FIG. 1 depicts an exemplary diagram of a system environment 100 for implementing the principles of embodiments of the present invention. As shown in FIG. 1, system 100 may include a personal computer (PC) 102, a personal digital assistant (PDA) 104, echo device 106, television 108, digital video disk (DVD) player 110, video-cassette recorder (VCR) 112, audio system 114, security system 116, and sprinkler system 118. While only a few home electronic devices are depicted in FIG. 1, it may be appreciated by one of ordinary skill in the art that additional devices may operate within the system environment. For example, environment 100 may further include electrical devices, i.e., lights, appliances, fans, shades, garage door openers, and heating systems and cooling systems. Additionally, environment 100 may include a variety of home electronics, alarm systems, fire alarm systems, lock systems, etc. Each device depicted in FIG. 1 includes either a single arrow or a double arrow.

Where the device includes a single arrow, this indicates that the device may either receive or transmit data in the direction the arrow is pointing. Where the device includes a double arrow, this may indicate that the device may transmit and receive information. It may further be appreciated that the devices depicted in environment 100 may respond to data in a variety of formats, including consumer IR, X10, HTTP, S-Link, and other formats of software control data. Echo device 106, PC 102, and PDA 104 may be implemented as smart devices while TV 108, Audio 114, DVD 110, VCR 112, sprinkler 118, and security 116 may be implemented as controlled devices. It may further be appreciated that the controlled devices may include double arrows where two-way communication between the controlled device and the smart device may take place.

It may further be appreciated that the smart devices, i.e., PDA 104 and PC 102 may be connected to the Internet that would allow additional communication channels through the Internet. For example, PDA 104 and PC 102 may connect to the Internet in order to retrieve information for user in the system consistent with principles of embodiments of the present invention. Additionally, a client device operating on the Internet may transmit commands to PDA 104 and/or PC 102 in order to control controlled devices as discussed herein. In this manner, the PDA 104 and PC 102 may be configured to receive messages, i.e., AOL Instant Message, MicroSoft's Messaging, or SMS messaging, where the system would parse the message to determine if the message included a command. If the message included a command, the system would process the command data as discussed herein.

Environment 100 additionally includes a variety of smart devices, including PC102, PDA 104, and echo device 106. It may be appreciated by one of ordinary skill in the art that additional smart devices may be implemented in system 100, including a computing device operating a CE, Pocket PC, or Palm Operating Systems, or running embedded programming systems and capable of communicating using standard protocols. It may further be appreciated that while only one instance of each device is shown, additional instances may be implemented, i.e., system 100 may include two personal computers where each of the personal computers function in accordance with the functionality as described with regard to PC 102.

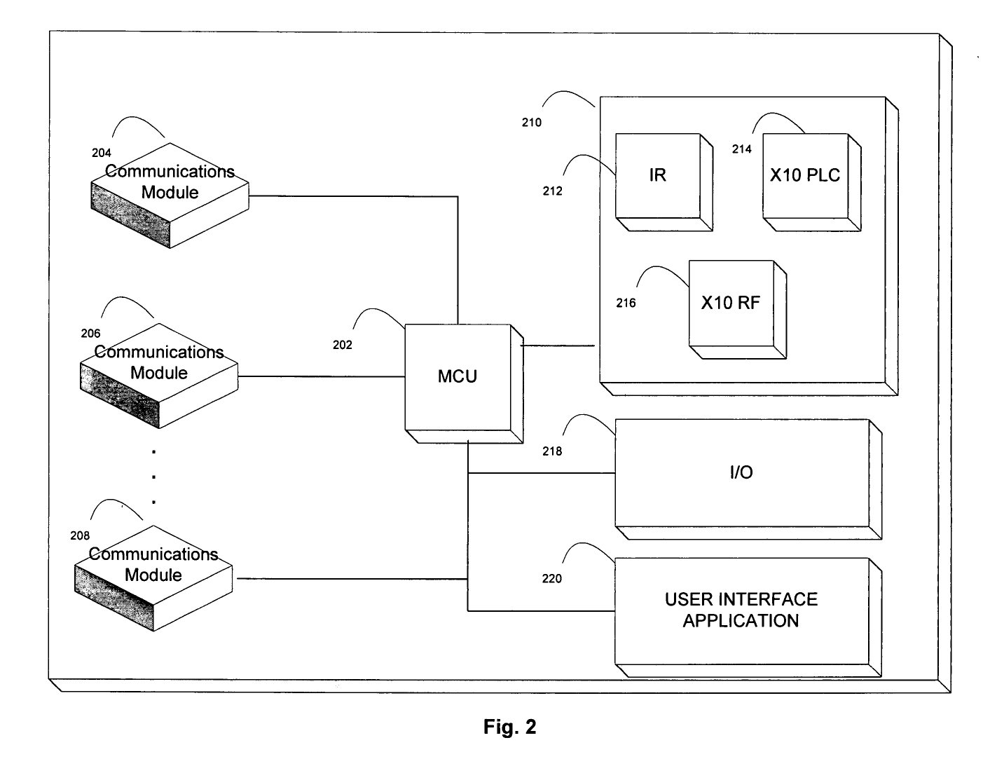

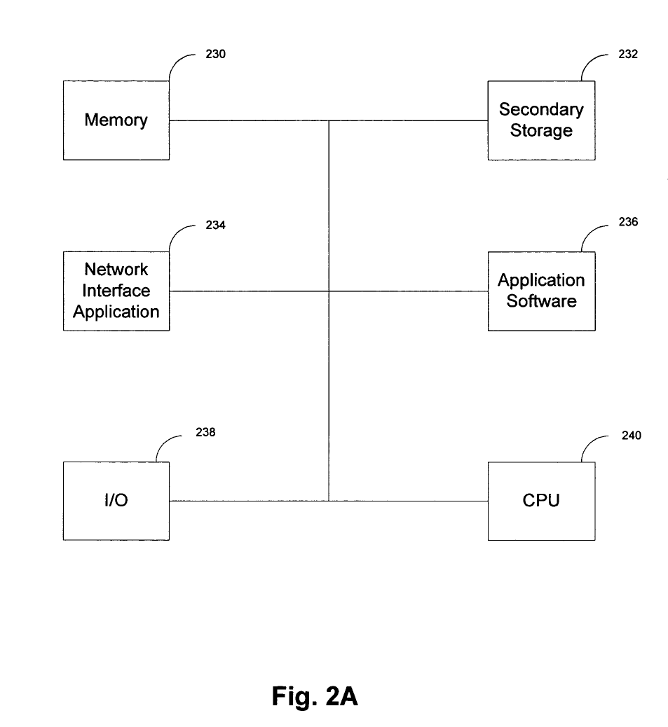

FIG. 2 depicts an exemplary block diagram of echo device 106 that may be implemented in system environment 100, consistent with the principles of embodiments of the present invention. As shown in FIG. 2, echo device may include micro-controller unit (MCU) 202, communication modules 204, 206, and 208, controllers 210 including IR controller 212, X10 power line carrier (PLC) controller 214, and X10 radio frequency (RF) controller 216, input/output devices 218, and user interface application 220. Communication modules 204, 206, and 208 may provide the echo device 106 with the ability to communicate with various devices depicted in environment 100 over standard or non-standard protocols, wired or wireless IP, including standard Ethernet twisted pair (802.3), wireless Ethernet (802.11), Bluetooth®, and serial via RS232 or universal serial bus (USB). It may be appreciated by one of ordinary skill in the art that additional protocols may be used.

MCU 202 may provide the logic engine of the echo device 106. MCU may receive commands and data from a communications module and may utilize internal routing tables to route the command and data to the proper output. This output may be another communications module, allowing the command or data to be bridged across different protocols. Alternatively, the output may be one of the controllers 210. If the command or data is routed to one of controllers 210, the MCU may process this command or data and further may drive the controller accordingly. The MCU may further monitor the controllers 210 for event activity such as an incoming signal. Upon receiving an event, the MCU may determine the proper routing of the event and its data either to a communications module 204, 206, or 208, or a controller 210. The MCU's internal program and routing tables may be updateable by downloading new code and data using any of the communication modules 204, 206, or 208.

Controllers 210 may provide direct control of external devices. Each controller may be driven directly by the MCU and includes the required hardware to send and receive its specific protocol. Infrared controller 212 controls using consumer infrared. X10 PLC controller 214 controls using X10 protocol directly on the power line. X10 RF controller 216 controls using X10 protocol via radio frequency. It may be appreciated by one of ordinary skill in the art that additional controllers may be included in controllers 210 including S-Link™ controller, CEBus controller, hypertext transfer protocol (HTTP) controller, IP controller, and Bluetooth™.

Input/output devices 218 may include, for example, a keyboard, a mouse, a display, a storage device, and/or a printer. Additionally, users may interact with echo device 206 through input/output devices 218 via user interface application 220. PC 102 may be implemented as a smart device that may be used to initiate commands to other devices included in environment 100. It may be appreciated by one of ordinary skill in the art that other devices may be implemented as the smart device including, but not limited to a PDA, a universal remote control, etc. It may further be appreciated by one of ordinary skill in the art that the smart device may be implemented by a computing device running a CE operating system, a computing device running a Pocket PC operating system, a computing device running a Palm operating system, a computing device running a Windows operating system, or a computing device running embedded programming systems and capable of communicating using standard protocols.

Personal computer (PC) 102, personal digital assistant (PDA) 104, echo device 106, television 108, digital video disk (DVD) player 110, video cassette recorder (VCR) 112, audio system 114, security system 116, and sprinkler system 118 may be implemented using suitable combinations of conventional hardware, software, and firmware. Television 108, digital video disk (DVD) player 110, video-cassette recorder (VCR) 112, audio system 114, security system 116, and sprinkler system 118 may be referred to as controlled devices within this disclosure.

A controlled device may be a passive device that only accepts a command via a certain protocol with no response, a semi-active device that accepts a command via a certain protocol and returns a status indicating completion of the command, or an active device that accepts a command via a certain protocol and returns response data in accordance with the command received. Further, a controlled device may actively initiate an event that the controllers, or smart device, may sense and react to. Additional examples of controlled devices include, but are not limited to, electrical appliances such as lights and thermostat control, home entertainment devices, computer systems and the applications on the computers.

FIG. 2A depicts an exemplary block diagram of PC 102 that may be implemented in system environment 100, consistent with the principles of embodiments of the present invention. As shown in FIG. 2A, PC 102 includes memory 230, network interface application 234, secondary storage 232, application software 236, central processing unit (CPU) 240 and input/output devices 238. Input/output devices 238 may include, for example, a keyboard, a mouse, a video cam, a display, a storage device, and/or a printer. PC 102 may be communicably linked with other devices included in environment 100.

Device Registration and Training

In creating environment 100, for each device included in environment 100, the user may register the device with the system. For example, PC 102 may include software, including a series of user interface screens including one or more interviews, where the user may enter information regarding the device. For example, the interview may include a menu where the user can enter the make and/or model of the device. By entering this information, the system may retrieve pre-stored information regarding the capabilities of the device. Where the device is VCR 112, by entering the make and/or model of the VCR 112, the system may retrieve information relating to the capabilities of the device. For example, the PC may retrieve information indicating the VCR 112 may respond to a series of commands, including PLAY, STOP, REWIND, FAST-FORWARD, etc. The user may enter additional information, for example, the location of the device, including what floor of the house the device is located on and what room the device is located in. Additionally, information relating to the manner that the device may send and/or receive information, i.e., what communication protocols the device is able to send and/or receive information.

Alternative to the make and/or mode that is entered, the user may enter the UPC code located on the device. Using this UPC code, the PC may obtain the capabilities of the device. Alternative, or in addition, to retrieving information using the make and/or model or the UPC code, the user may enter the capability information manually.

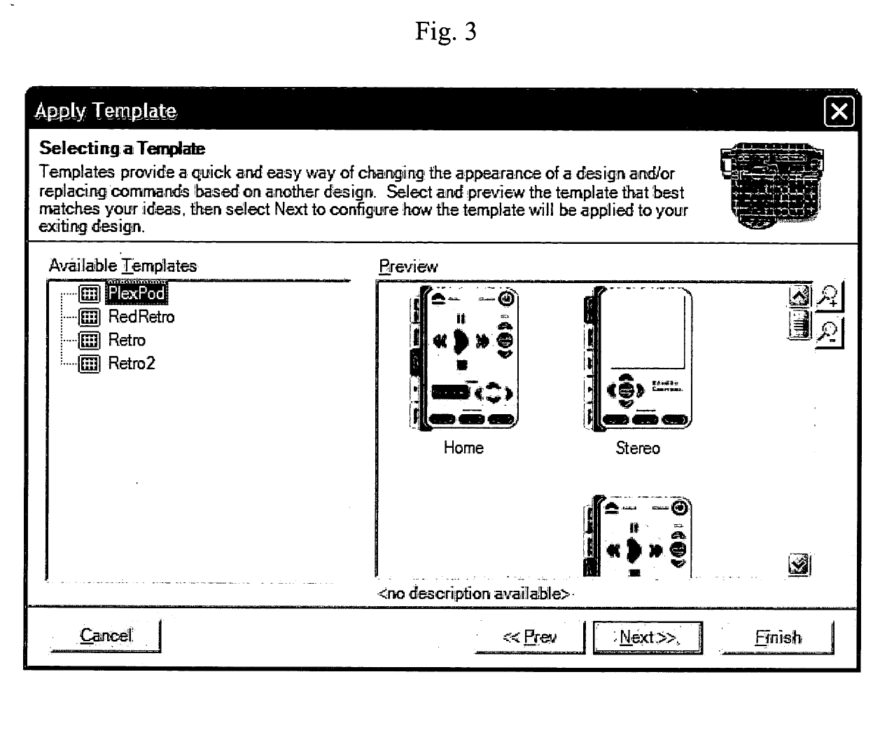

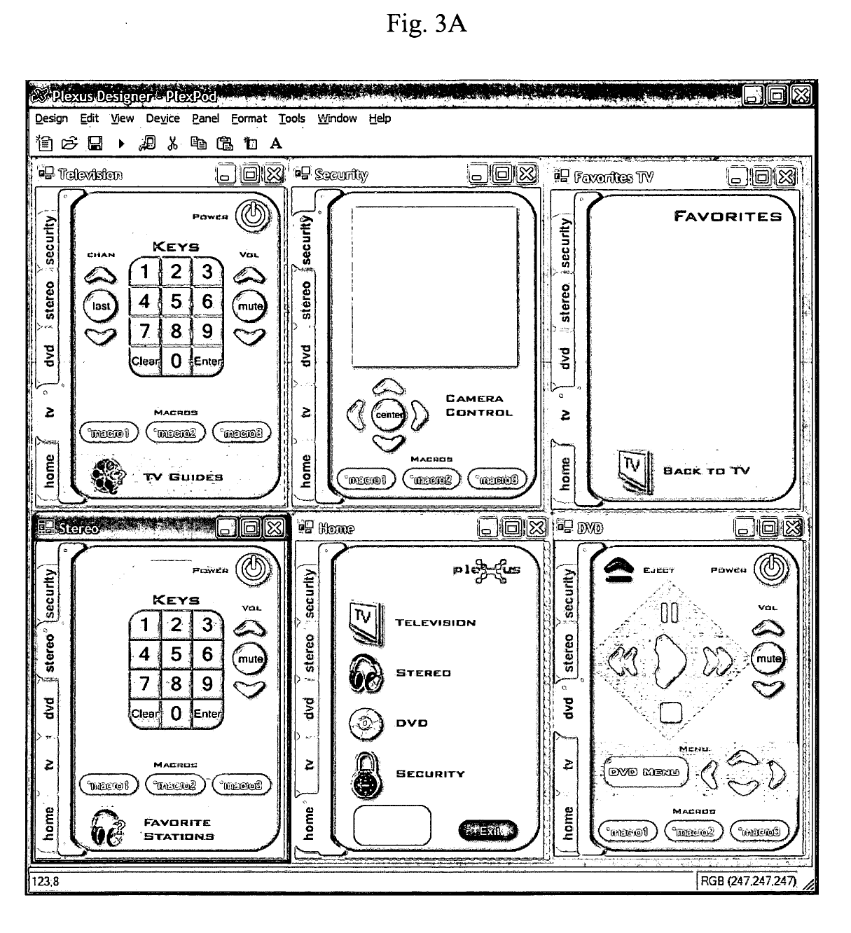

Once the capabilities of the device are determined, the user may select the appearance of the remote control that will be displayed on a selected controller. The user may select from a plurality of template remote control templates that include buttons corresponding to the capabilities of the device. FIG. 3 depicts an exemplary screen shot presented to a user where the user may select a template for the remote control. As shown in FIG. 3, the user may select from four available templates, namely PlexPod, RedRetro, Retro, and Retro2. These different templates may have different appearances, however, functionally, the templates operate similarly. Once the user selects a particular template, the user may be presented with a screen shot as depicted in FIG. 3A where the user may view the different remote control templates as they apply to different controlled devices within the household or business. Here, the user may add additional functionality to the remote controls based upon the operational abilities of the controlled device. For example, while the predefined template may include a PLAY, STOP, REWIND, and FASTFORWARD command for a VCR, the user may add additional commands to the remote control where the VCR is capable of additional operations.

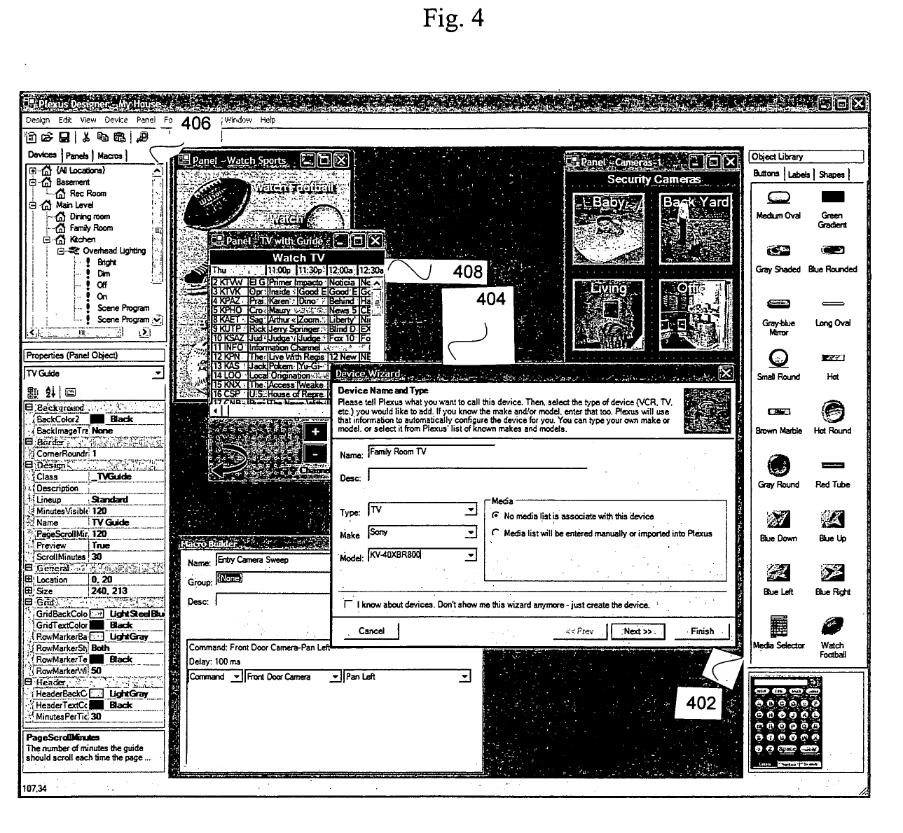

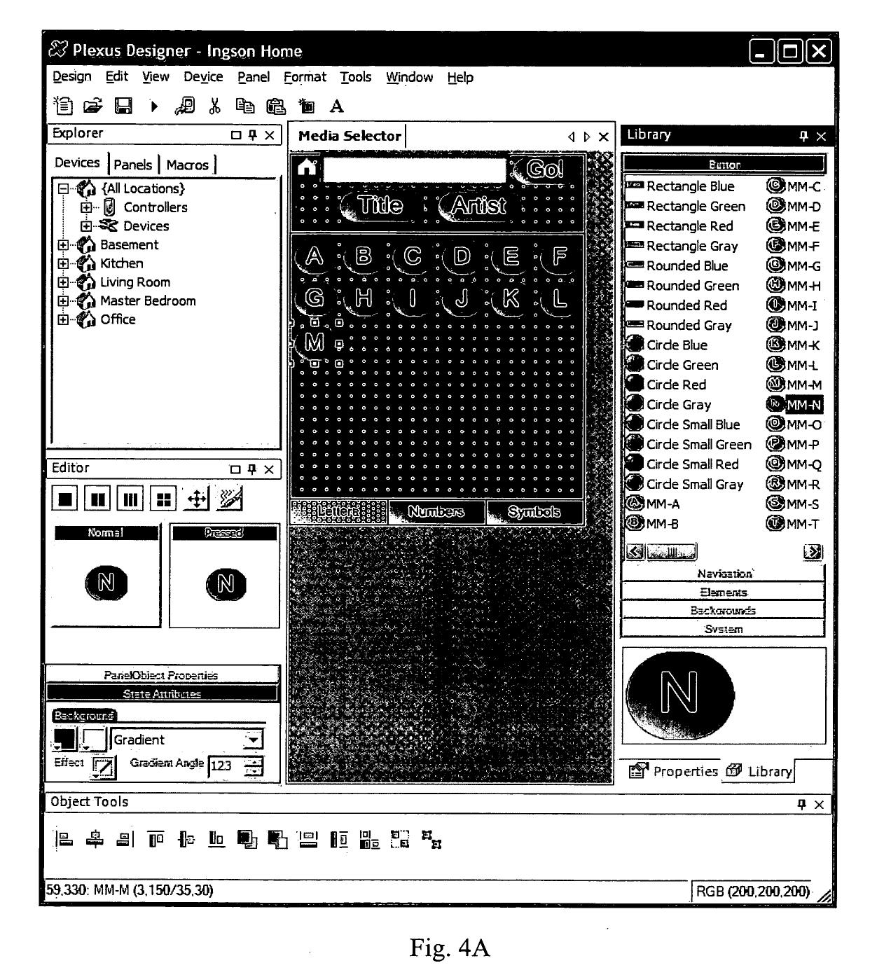

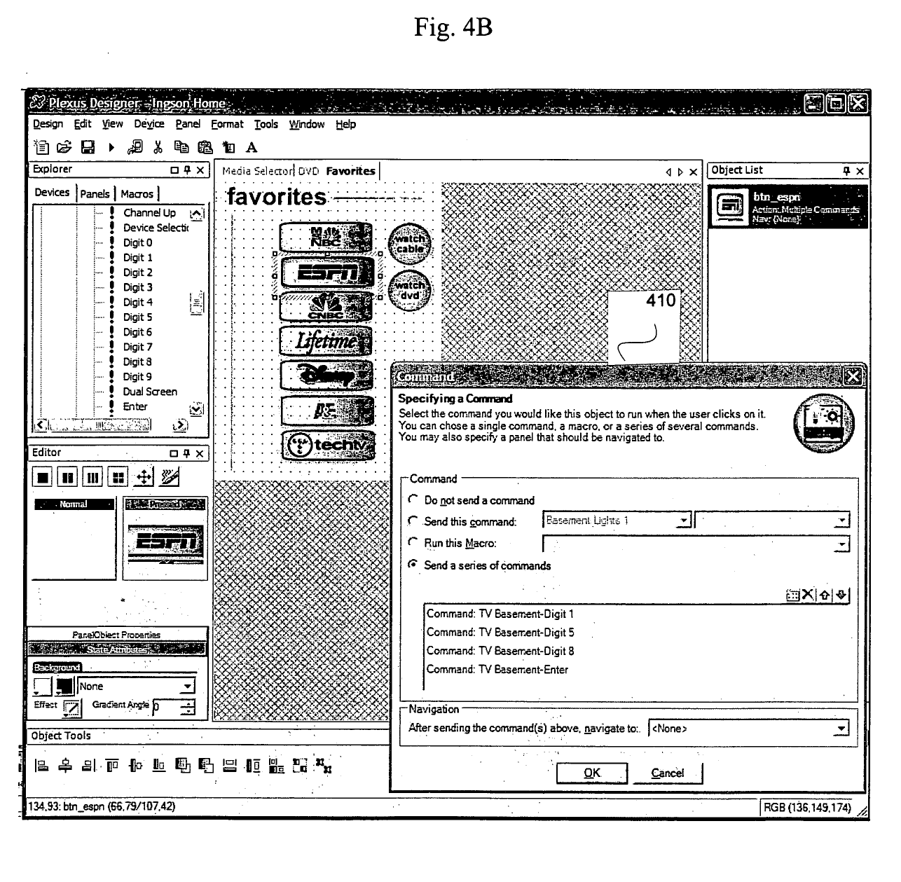

Alternatively, the user may interactively design the template for the remote control using software stored on the PC. FIG. 4 depicts exemplary screen shots presented to a user. Utilizing object library 402, the user may drag and drop buttons, labels and shapes to a blank template where the user can design a custom remote control template. The buttons in object library may include a number of states, i.e., selected, unselected, disabled/pressed and disabled/unpressed. Disabled indicates the user is unable to affect the state of the button. Once the look of the remote control template is completed, the functionality of the buttons, labels and shapes may be assigned. Device Wizard 404 provides an Interview for the user to select the name of the remote control and input information regarding the type of device. Once this information is received, the functionality of the buttons, labels and shapes may be defined similar to the process described herein regarding template remote controls.

FIG. 4A depicts and exemplary user interface screen display presented to a user that may facilitate the creation of a custom remote control. As shown in FIG. 4A, the user may create a remote control that facilitates selecting media. In creating the media selector remote control, as shown in FIG. 4A, the user has already created the “title”, “artist” and “go buttons. This may be accomplished by dragging and dropping buttons from the Library to the remote control template. As shown in the Media Selector remote control, the user has just dragged and dropped “M” to the remote control template. Once a button has been established on the remote control template, a command may be associated with that button. For example, the letter M may be associated with button “M”, where, when the button is selected, the letter M may be a command which may ultimately be transmitted to the controlled device.

It may be appreciated by one of ordinary skill in the art that this process may be similarly executed for any controlled device wherein the user may create a custom remote control by dragging, dropping, and defining buttons. These buttons may then be associated with a command such that when the user-defined button is pressed, the associated command is transmitted to the controlled device.

There may be situations where the device includes additional capabilities that were not determined from the initial device registration. For example, where VCR 112 performs an additional function, the user may include an additional button on the remote control template and train the controller to perform that additional function by using the remote control that was shipped with VCR 112.

Alternative to the features discussed above, the user may select to train the controller solely using the remote control that was shipped with VCR 112. In this instance, the user may select a training interview software application from PC 102. Once this interview is selected, the user may be prompted to push buttons on the remote control shipped with the VCR 112 in a certain order to train the remote control template to perform the same operations. For example, upon selecting the training interview, the user may be prompted to push the PLAY button on the remote control shipped with the VCR. Upon receiving the RF or IR signal generated by the remote control signal shipped with the VCR, the PC may associate that command with the PLAY button of the remote control template for the controller. The user may then be prompted to push the STOP button, and so on, until such time that all of the buttons on the remote control shipped with VCR 112 have been pushed and received by the PC.

This process may be performed for each device in environment 100. In this manner, 102 PC may store all of the information relating to each device. As the devices are input into the system, screen 406 provides an overview of the devices that have been registered with the system. As shown in screen 406, the devices may be categorized by their location in the house. For example, an overhead lighting fixture is registered in the kitchen and has a number of functions associated with it. For example, the fixture may be bright, dim, off, on, etc. As such, a user may quickly ascertain what devices are registered in the system and further, what functions are associated with the devices.

Additionally, the user may access the remote controls and any additional features that are associated with each of the devices by selecting the Panels thumbnail in screen 406. For example, the user may select to view the TV guide, thus being presented with screen display 408. The TV guide may be fully customizable where the user may select any manner in which to view the TV guide, including organizing the order and the channels are displayed, what channels may be removed from a viewing list whereby children are unable to view certain channels, etc. Additionally, the TV guide may manually or automatically update upon connection to a network, such at the Internet, to download any program updates.

In addition, the user has the ability to create macros, in the form of single or multiple commands strung together. Once the macro is established, the user may drag and drop a button to the custom remote control. The user may then associate the macro with a particular button on the remote control, where, when the button is selected, the macro is run, and the commands associated with the button are processed for execution on the controlled device.

For example FIG. 4B depicts an exemplary screen display presented to a user where the user may create macros for the remote control. The user may, for example, create a button on the remote control that commands the TV to tune in directly to ESPN without having the user enter the channel digits. As shown in FIG. 4B, the user, through user input screen display 410, may insert commands instructing the basement television to enter the digit 1, enter the digit 5, enter the digit 8, and finally enter the “enter” command. This string of commands may then be associated with the ESPN button that was entered in the “Favorites” template of the basement remote control. As such, when the user pushes the ESPN button, the macro may be executed and the basement TV may ultimately tune in to ESPN.

It may be appreciated by one of ordinary skill that any command that may be received and interpreted by a controlled device may be incorporated into macros that may be associated with buttons on a remote control.

Event Handling

In addition to the information described above, the user may enter information that specifies certain actions that should occur when a certain event is received by the system. In environment 100, those devices that are capable of two-way communication may trigger an event. For example, security 116 includes a security system that includes cameras strategically placed through a home, i.e., the front door, the back door, in the baby's room, etc. Upon detection of a person at the front door, security 116 may trigger a signal that may be sent to PC 102. This signal that may be sent to PC 102 constitutes an event. The user may configure the system so that, upon detection of a person at the front door, a message may be sent and displayed on the controller display so that the user may be notified that someone is at the front door. Alternatively, upon detection of movement in the baby's room, the system may trigger an event. An event may be based upon a certain time, may be based upon a certain detected action, i.e., where the camera detects motion, an event may be triggered, may be based upon proximity detection, i.e., where the controller detects a certain controlled device, etc.

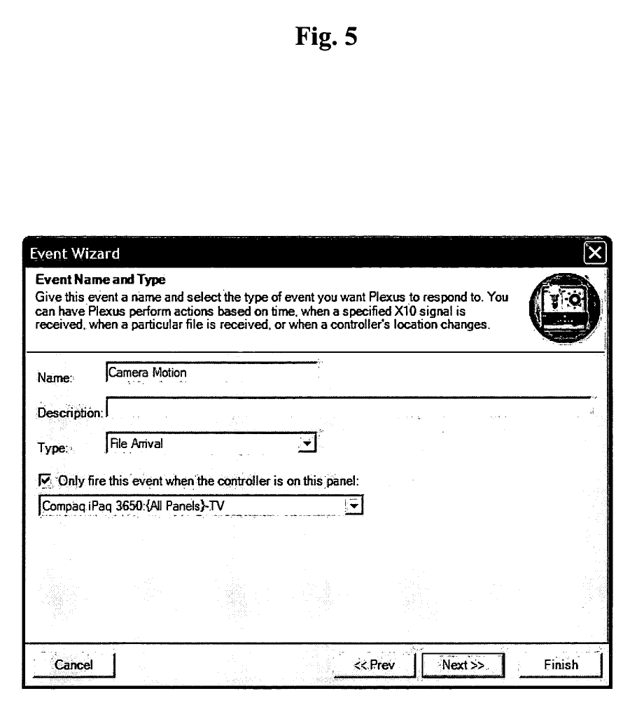

FIG. 5 depicts an exemplary screen display presented to the user where the user can instruct certain actions to occur based on the triggering of an event. As depicted in FIG. 5, the user may specify the name of the event and the type of event the system may respond to. Additionally, the user may specify to perform the action regardless of the controller used, or the user may specify the action to occur when a particular controller is used.

Operating the Controller

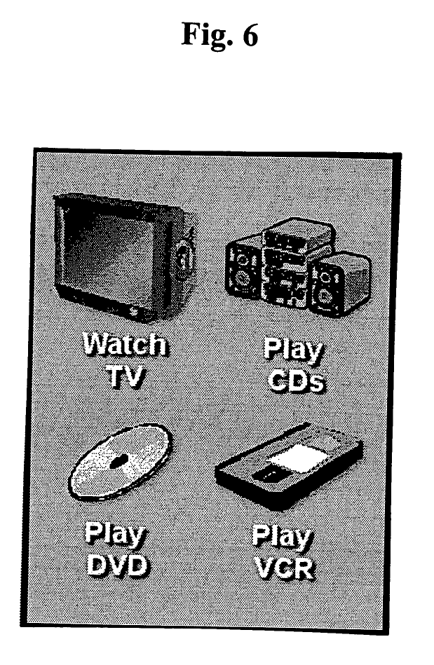

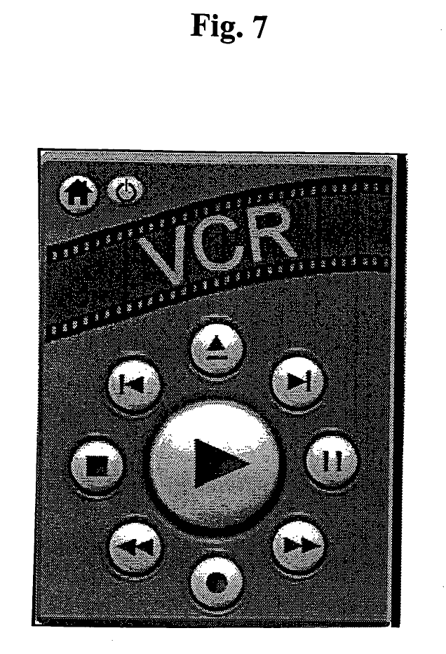

Once devices are registered and the remote control templates in PC 102 are trained to remotely control the devices, the user may remotely control any of the devices by solely interfacing with the controller. In this example, the controller may be implemented as a Compaq iPaq PDA. However, any other suitable device may be implemented as the controller. For example, PC 102 may additionally be implemented as the controller. The information from PC 102 may be uploaded to the iPaq PDA. In order to remotely control the devices included in environment 100, the user may interface with the remote control templates. FIG. 6 depicts an exemplary screen display presented to a user whereby the user may select the device to control. As depicted in FIG. 6, the user may select to control television 108, audio 114, DVD player 110, or VCR 112. If the user selects VCR 112, the screen display depicted in FIG. 7 may be presented to the user. As shown in FIG. 7, the remote control template the user selected in the registration and training stage appears on the screen. The user may remotely control VCR 112 using the remote control template. The user may similarly control all of the devices that have been registered and trained in environment 100.

Routing User Initiated Commands to the Specified Controlled Device

Once the controller receives the command, the controller may consider the capabilities of all of the devices in environment 100 to determine the communication capabilities. Based upon the devices communication capabilities, the controller may create a routing table including all of the possible routes the command may take in order to remotely control a controlled device. Once the routing table is created, the controller may select a route and transmit the command data. In selecting the route, the controller may select the first route in the routing table. Alternatively, the controller may select the route that utilizes the least number of devices. A route may include being transmitted to a controlled device through any number of intermediary devices, which may communicate using a variety of different protocols. An intermediary device may be any device that may be interposed along a route between the controller and the controlled device.

It may be appreciated by one of ordinary skill in the art that in alternative to the routing table being created, the routing table may be predetermined or download by another smart device.

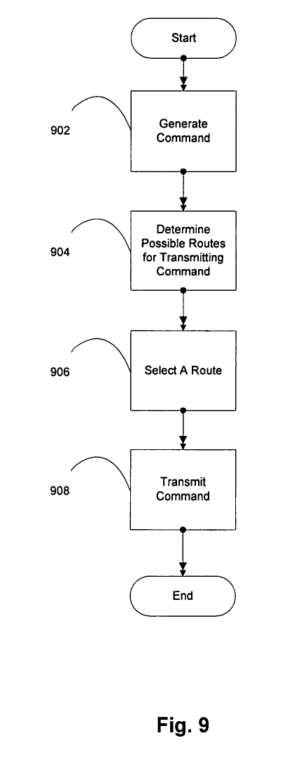

FIG. 9 depicts an exemplary flow diagram of the steps performed by a controller in routing user-initiated commands to a specified controlled device. As shown in FIG. 9, the controller may generate a command to control a controlled device based upon user input (Step 902). The controller may then obtain all communication information regarding each of the devices included in environment 100. Using the communication information, the controller may create a routing table that includes all possible routes the command can take through the devices in environment 100 to reach the controlled device (Step 904). Once the routing table is generated, one route is selected (Step 906). This route may be selected using a variety of methods known to one of ordinary skill, including selecting the first route, selecting the route with the least amount of devices, etc. Finally, the command may be transmitted based upon the route selected (Step 908).

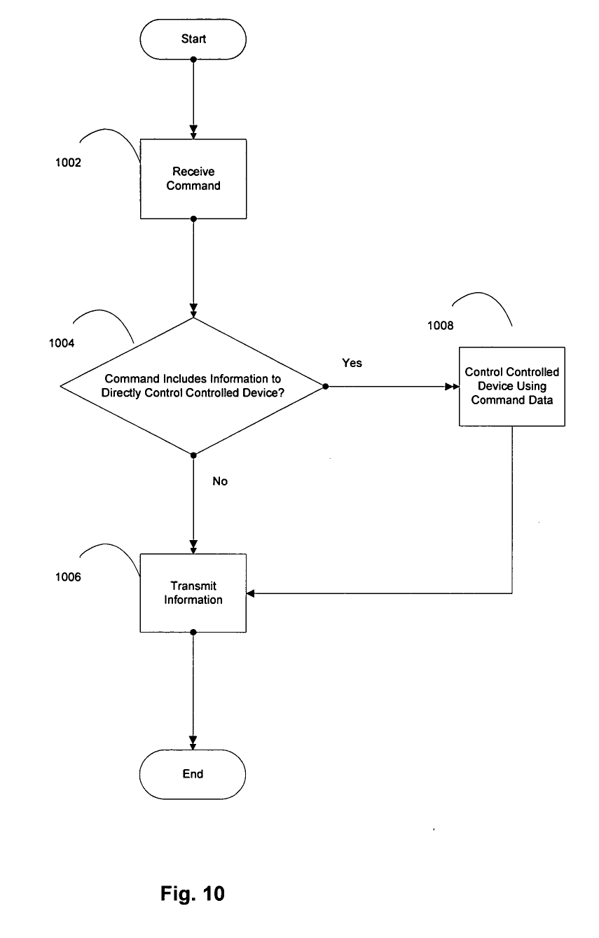

FIG. 10 depicts an exemplary flow diagram of the steps performed by the echo device 106 in routing user initiated commands to a specified controlled device. As shown in FIG. 10, the echo device receives the command that was initiated by the controller. This command may be received directly from the controller, or by another smart device in environment 100 that is included in the routing of the command determined by the controller (Step 1002). Once the command is received, echo device 106 determines, based upon information included in the command if the echo device should control the controlled device directly or should transmit the command to the next device on the route (Step 1004). If the command indicates the echo device should directly control the controlled device, (Step 1004, Yes), the echo device 106 retrieves raw command data from the command and directly controls the control device (Step 1008). If the command indicates the echo device should transmit the command to the next device on the route (Step 1004, No), the echo device transmits the information to the next device on the route (Step 1006).

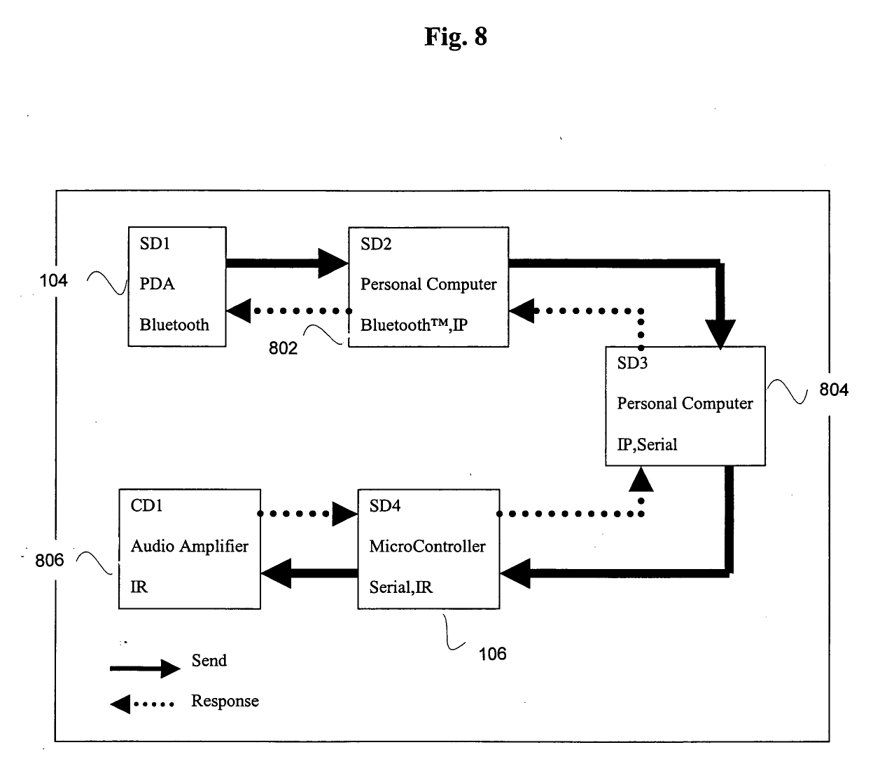

The following example is given to help aid in describing the methodology presented in this invention. This is only one possible scenario in which this invention applies and does not limit the use of this invention to numerous other scenarios. FIG. 8 shows the components involved in this example. SD1 (smart device 1) may be implemented as PDA 104 such as a Compaq iPaq™ with Bluetooth™ communication capabilities. SD2 (smart device 2) may be implemented as a Personal Computer 802 with both Bluetooth™ and IP communication capabilities. SD3 (smart device 3) may be implemented as a Personal Computer 804 with IP communication capabilities and utilizes its serial port to communicate with SD4. SD4 (smart device 4) may be implemented using echo device 106, a Microprocessor based hardware component that communicates via Serial transmissions and emits Consumer IR signals via an Infrared LED. CD1 (controlled device 1) may be implemented as an off the shelf audio amplifier hooked to an in-house speaker system 806. CD1 may be controlled by IR signals.

The process of routing a command begins when the user interacts with SD1 via a software application running on SD1. This interaction may be pushing a soft button, typing in a command, or pushing a hard button on SD1. This interaction creates an event within the software application. This event has a predetermined Command Id assigned to it that identifies the Command to be sent. Utilizing a predefined routing table (to be explained later in this document), the final destination for this command, SD4 (the smart device that will issue the IR command) may be determined. The command data within the routing tables also contains the raw data to control CD1, the controlled device. In this case the command data would hold the raw timing values to create the proper IR pulses to be sent to CD1.

Once the destination is determined, the available routes are retrieved from the routing table. Each available route may contain a condition to validate its use, such as which user screen the command was issued from. If multiple routes are available after conditionals are evaluated, the first route may be attempted. For the selected route a component may be initialized with a set of parameters to either issue the raw data command on the smart device or route the raw data command to another smart device. In this example, since SD1 is unable to issue IR commands, a data packet containing the raw data command may be routed via Bluetooth™ to SD2. SD1 first establishes a connection to SD2, then sends the data packet via Bluetooth™ to SD2 and waits for a return status. If the communication fails, SD1 then proceeds to the next available route for the given Command and so forth until it either successfully sends the command, or fails all routes.

When SD2 receives the data packet via the Bluetooth™ connection from SD1, it determines the final destination, SD4, for the Command from the data packet. Since SD2 is not the final destination, it uses its own local routing table to lookup the routes available to route the Command. Again, similar to SD1, multiple routes may be available to send the Command on to SD4. Using conditionals and order priority, SD2 determines that an IP connection can be established to SD3. SD2 makes a connection to SD3 and sends the data packet (containing the raw IR data) to SD3 over an IP socket connection. It then waits for a response and determines if the route completed successfully or if it needs to try the next route available.

Similar in process to SD2, SD3 receives the data packet from SD2 via IP and utilizes its local routing table to determine the next route for the Command. In this example it establishes a Serial connection to SD4 and transmits the data packet to SD4 via serial communications.

Upon receiving the data packet from SD3, SD4 may determine that it is the final destination for the Command and extracts the IR raw data from the data packet. Using this raw data it initiates its local hardware devices to emit the IR transmission, activating CD1. Upon successful transmission of the IR signal, SD4 returns success via the serial communication to SD3 which in turn responds to SD2 via IP as successful which in turn response to SD1 via Bluetooth™ as successful.

Another example could have CD1 as an http camera in which case the raw data sent from SD1 would be the http command sequence to operate the camera. In this case response data, such as an image, would be returned from CD1 via each of the communication protocols in the example, back to SD1 and displayed on the user interface.

In order to dynamically route commands as new smart devices or controlled devices are added to the system, routing tables are created and deployed to each smart device. These tables are generated by a central software application that may be used by the end user to configure their system. Each table may be configured for the specific smart device it is deployed to, optimizing the communications routes to use to traverse the system to the final destination. These optimizations take into account the type of communication available, the reliability of each communication link, and the user's preference for routing.

In one implementation of the present invention, routing tables on a specific smart device do not contain the entire route, but only the next hop within a route. This allows dynamic reconfiguration of system components with minimum impact.

Routing tables in accordance with one implementation of the present invention are comprised of three categories of data, Command Data, Destination Data and Command Handler Data. The routing process utilizes these three categories of data to create the data packet to be routed, and to initiate the system to properly route this packet. Each of these categories is described as follows.

Command data may include: a Command Id used to lookup the appropriate Command data for the given User Interaction; a Command Name, which may be optional, as an alternative way to lookup the appropriate Command data for the given User Interaction; a Command Class which indicates the classification of the data, such as infrared, X10, etc.; a Type which indicates the format of the Command data, being either String or Binary; a Destination Id which identifies the Destination data to process in order to route the Command; and the Command data itself, the raw data processed by the final destination device to control the controlled device.

Destination Data may include: a Destination Id used to lookup the appropriate Destination data; a Destination Name, which may be optional, as an alternative way to lookup the appropriate Destination data; and Multiple Routing records where each record may include: a Command Handler Id which indicates the Command Handler that will be used to process the given route; and a Condition which may be used to determine if the given route is valid for the current context of the system.

Command Handler Data may include: a Command Handler Id used to lookup the appropriate Command Handler data; a Type which indicates the type of the Command Handler, examples being a Command Processor, Transport or a Listener; a Package Type which indicates the type of software system component that the given Command Handler logic is contained in, examples being a .Net assembly or a COM component; an Assembly Name which indicates the file system name of the component that the given Command Handler logic is contained in; an Object Name which indicates the internal object within the Assembly that the given Command Handler logic is contained in; and a Setup string which provides the Command Handler initialization information for the given instance of the Command Handler.

Two separate processes are deployed within the system to achieve routing of Command data from the initial smart device to the final destination device.

The first process used to route Command data occurs on the initial smart device when the User or system initiates a Command. The following steps are used to process this command on the smart device using the above-mentioned routing tables.

The system requests the routing subsystem to send a Command, passing in the Command Id (or Command Name), the Commands Parameter data and the number of times the Command should be repeated.

The appropriate Command Data may be retrieved from the routing tables using the Command Id (or Command Name).

A data packet may be created which may include the packet length, packet version, Destination Id, Repeat Count, Hop Count, Command Class, Command Type, Command Data, Parameter Data, and Checksum.

The Destination Id from the Command Data may be used to lookup the appropriate Destination Data within the routing tables.

Routing records within the selected Destination Data are processed in order until one is located where its condition resolves to a true state given the current system context. This is considered the current route. If there are no available routes for the given context, an error is returned to the calling system.

From the current route record, the Command Handler Id is used to retrieve the appropriate Command Handler Data from the routing tables.

Using the Package Type, Assembly Name and Object Name, an instance of a Command Handler may be created and initialized with the Setup string provided by the current Command Handler data.

This Command Handler instance may be then passed the data packet previously created and the Setup string.

If the Command Handler Type may be a Command Processor: a) The Command Handler extracts the required information from the data packet needed to carry out the command; and b) the Command Handler processes the data to carry out the command. This processing may involve the interaction of the system with some hardware component, or some additional software components residing on the current smart device.

If the Command Handler Type may be a Transport: a) The Command Handler establishes a connection to a remote smart device, where each Command Handler has a pre-determined connection method such as IP, Bluetooth, or Serial. The remote device to connect to is determined by the Setup string; b) The Command Handler then sends the data packet to the remote device and waits for a response; and c) Processing of the data packet on the remote device is described below.

Upon processing completion, the Command Handler returns to the routing subsystem a response packet, which contains an error code and response data if the given Command generated response data.

If no error occurred within the processing by the Command Handler, a Success status may be returned to the calling system.

If an error occurred within the processing by the Command Handler, processing cycles back to processing routing records within the selected destination data discussed above, where the next available route may be determined.

The second process used to route Command data occurs when a smart device receives a Command data packet from another smart device within the routing process. The following steps are used to process this data packet on the smart device using the above-mentioned routing tables.

Upon system initialization the routing subsystem scans the routing table Command Handler data for all Command Handler records of type Listener. Using the Package Type, Assembly Name and Object Name, an instance of each Listener type Command Handler may be created and initialized with the Setup string provided by the current Command Handler data. Each Command Handler, having a predetermined connection method such as IP, Bluetooth or Serial creates the necessary resources to ‘listen’ for incoming connections from other smart devices. When a request is made to one of the Listener type Command Handlers, the Command Handler establishes a connection with the calling smart device. A data packet may be received consisting of the packet length, packet version, Destination Id, Repeat Count, Hop Count, Command Class, Command Type, Command Data, Parameter Data, and Checksum.

The Hop Count may be incremented and checked against the system configured maximum Hop Count parameter. If the Hop Count exceeds this maximum, the Listening Command Handler response to the calling smart device with an error. This check is to assure a recursive situation does not occur in the overall system. The Destination Id from the Command Data may be used to lookup the appropriate Destination Data within the routing tables. Routing records within the selected Destination Data are processed in order until one is located where its condition resolves to a true state given the current system context. This is considered the current route. If there are no available routes for the given context, an error response may be returned to the calling system. From the current route record, the Command Handler Id is used to retrieve the appropriate Command Handler Data from the routing tables. Using the Package Type, Assembly Name and Object Name, an instance of a Command Handler may be created and initialized with the Setup string provided by the current Command Handler data. This Command Handler instance may be then passed the data packet previously created and the Setup string.

If the Command Handler Type is a Command Processor: a) The Command Handler extracts the required information from the data packet needed to carry out the command; and b) the Command Handler processes the data to carry out the command. This processing may involve the interaction of the system with some hardware component, or some additional software components residing on the current smart device.

If the Command Handler Type is a Transport: a) The Command Handler establishes a connection to a remote smart device, where each Command Handler has a pre-determined connection method such as IP, Bluetooth, or Serial, and the remote device to connect to is determined by the Setup string; and b) The Command Handler then sends the data packet to the remote device and waits for a response.

Upon processing completion, the Command Handler returns to the Listening Command Handler a response packet, which contains an error code and response data if the given Command generated response data. If no error occurred within the processing by the Command Handler, the Listening Command Handler returns the Response packet to the calling system. If an error occurred within the processing by the Command Handler, processing cycles back to the step where routing records within the selected Destination Data are processed in order until one is located where its condition resolves to a true state given the current system context, where the next available route is determined.

When a Command is initiated within the system, at a minimum, the first routing process may be initiated. Depending on the system configuration, the second routing process may be initiated by the first process when a connection is required between two smart devices. The second process may occur up to a system-configured set of times, defined as hops. At no time within the routing system is process one ever initiated more than once for a given Command. It may be appreciated by one of ordinary skill in the art that the second process may occur more than once between successive sets of smart devices.

It may be appreciated by one of ordinary skill in the art that the user may initiate a command by sending a message to the controller. For example, the user may send a message through, for example, AOL's Instant Messenger, MicroSoft's Messaging, or through SMS messaging. Once the controller receives the message, the controller retrieves the command from the message and processes is according to the methods discussed above.

Proximity Detection

According to an alternate embodiment consistent with principles of embodiments of the present invention, a methodology is provided to automatically alter or adjust the user's interaction with home and business automation system software. This alteration may be triggered by detecting the user's proximity within the environment and adjusting the software according to pre-prescribed rules created by the user. Determination of proximity will be discussed later in this document.

As a user moves around their home or business environment, the devices they wish to control will change according to their specific proximity to said devices. These devices include, but are not limited to, lights, Thermostat control, Home Entertainment control such as TVs, DVD players, Audio equipment, etc, Security systems, sprinkler systems, and Computer systems. As the system detects the users movement from one location to another, a set of rules based on location are processed and actions are executed, affecting the user's environment.

Types of actions that could occur include, but are not limited to, the following list.

The User Interface screen changes to a new screen on the handheld device being carried by the user. Example, the user enters the Kitchen and the PDA screen changes to a new screen with controls for the Kitchen TV and lights.

Additional buttons appear on the User Interface screen allowing additional actions. Example, the user enters the garage and new buttons appear on the PDA screen to arm or disarm the security system.

Buttons or controls disappear from the User Interface screen. Example, the user leaves the Family room and the controls for the TV and DVD player in the family room are removed from the PDA's screen.

Automatic control of devices. Example, as the user leaves the Family room the lights turn off.

Proximity may be detected utilizing signal strength from standard wireless technologies such as Bluetooth and 802.11. As the user moves around the environment they carry with them a smart device capable of communicating with other devices, for example over an RF based wireless protocol. In this implementation, other devices, also capable of RF based wireless protocols are strategically positioned around the environment and proximity to these devices may be determined real time by determining connectivity to these devices along with signal strength. This proximity may be determined by either the smart device being carried by the user or the stationary device. As the moveable device changes location, it continually monitors the strength between each of the stationary devices to determine which stationary device it may be closest to, messaging the controller when the location has changed. Once the device has determined a change in proximity of a given user, it then posts an event to the system to process the location based rules as describe above.

The following procedure is used to determine the current signal strength from each stationary device. A list of stationary devices may be obtained from configuration data providing the connection parameters for each stationary device. The movable device attempts to connect to each stationary device and on a user configurable time period, continues to attempt a connection until one is successfully made. Once a connection is made to a stationary device, the signal strength of the connection may be obtained. On a user configurable time period, the movable device obtains a new signal strength from each of the stationary devices. If a connection to a stationary device is lost, the movable device tries to reestablish the connection on a user configurable time period.

Once the moveable device has attempted to connect, and when connected, has obtained a signal strength from each of the stationary devices, it utilizes this signal strength to determine which stationary device is closest.

Although in theory, the strongest signal strength would be the closest, inadvertent fluctuations in signal strength from physical obstacles or radio interference can cause momentary inaccurate readings. To eliminate improper sensing of the closest stationary device, the following method may be used.

On each user configurable time period, the signal strength may be determined for each stationary device. If a connection to a stationary device cannot be made, its signal strength is considered to be zero, i.e., no connection. For each stationary device, a set of previous signal strengths may be maintained up to a user configurable number of samples. As each new signal strength may be read, it may be added to this list of samples and the oldest sample is removed. If the variation between the most recent signal strength and the last signal strength is above a predetermined threshold, additional samples at the current signal strength are added to the list of samples, one per threshold step. If the movable device loses its connection with the stationary device, the moveable device immediately tries to reconnect and if no reconnection can be made, the list of samples may be cleared and the signal strength of the stationary device is set to zero, i.e., no connection. For each stationary device, an average may be then calculated from all the samples and this average becomes the effective signal strength for the stationary device.

The stationary device with the highest signal strength may be considered the closest device. If two devices have the same effective signal strength, the one that was the previous highest signal strength may be still considered the closest. If neither of these two devices was the previous highest signal strength, the device with the higher signal strength in the recent samples may be considered the closest. When it may be determined that a new stationary device is closest, an event may be passed to the controller indicating the occurrence.

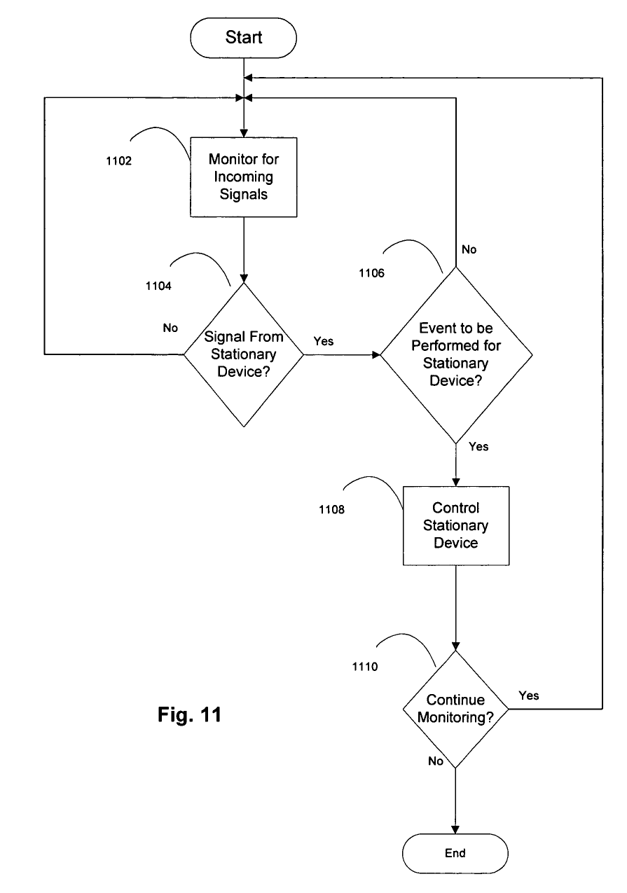

FIG. 11 depicts an exemplary flow diagram of the steps performed by the controller in performing events based upon proximity detection. As shown in FIG. 11, the controller monitors for incoming signals from devices in environment 100 (Step 1102). If a signal is received, the controller determines if the signal is from a stationary device (Step 1104). If the signal is not from a stationary device (Step 1104, No), the controller returns to a monitor state. If the controller determines the signal was transmitted by a stationary device, (Step 1104, Yes), the controller determines if there are any events to perform based upon the received signal (Step 1106). If there are no events, (Step 1106, No), the controller returns to a monitoring state. If there are events to be performed, (Step 1106, Yes), the controller controls the stationary device based upon the stored events that are to be performed (Step 1108). The controller may then determine whether to continue monitoring (Step 1110). If the controller determines to continue monitoring, the controller returns to a monitor state (Step 1110, Yes).

Modifications and adaptations of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of routing command data through a system including a plurality of smart devices and at least one controlled device, the method including:
generating a command to remotely control a controlled device;
determining possible routes for transmitting the command by considering the communication capabilities of all devices in the system;
selecting a route based upon the determined possible routes; and
transmitting the command based upon the selected route.

2. The method of claim 1, wherein the command is transmitted using a plurality of protocols.

3. The method of claim 2, wherein the protocols are not interdependent.

4. The method of claim 1, wherein transmitting the command includes transmitting the command to a smart device;
re-determining possible routes for transmitting the command by considering the communication capabilities of all devices in the system;
selecting a route based upon the determined possible routes; and
transmitting the command from the smart device based upon the selected route.

5. The method of claim 1 wherein the command is received or transmitted using at least one of wired IP, wireless IP, Bluetooth, serial communication, CEBus, and IRDA protocols.

6. The method of claim 1, wherein the command data includes at least one of Consumer IR, X10, HTTP, and S-Link data.

7. The method of claim 1, wherein one of the plurality of smart devices is a computing device running a CE operating system, a computing device running a Pocket PC operating system, a computing device running a Palm operating system, a computing device running a Windows operating system, or a computing device running embedded programming systems and capable of communicating using standard protocols.

8. The method of claim 1, wherein the at least one controlled device is a lighting fixture, home appliance, fan, shade, garage door opener, controller for a heating system, controller for a cooling system, television, digital video disk player, compact disk player, stereo receiver, alarm system, security system, lock system, or sprinkler system.

9. A system for routing command data through a system including a plurality of smart devices and at least one controlled device, the system including:
a memory for storing a program; and
a processor responsive to the program to
generate a command to remotely control a controlled device;
determine possible routes for transmitting the command by considering the communication capabilities of all devices in the system;
select a route based upon the determined possible routes; and
transmit the command based upon the selected route.

10. The system of claim 9, wherein the command is transmitted using a plurality of protocols.

11. The system of claim 10, wherein the protocols are not interdependent.

12. The system of claim 9, wherein the processor is further responsive to the program to
transmit the command to a smart device;
re-determine possible routes for transmitting the command by considering the communication capabilities of all devices in the system;
select a route based upon the determined possible routes; and
transmit the command from the smart device based upon the selected route.

13. The system of claim 9, wherein the command is received or transmitted using at least one of wired IP, wireless IP, Bluetooth, serial communication, CEBus, and IRDA protocols.

14. The system of claim 9, wherein the command data includes at least one of Consumer IR, X10, HTTP, and S-Link data.

15. The system of claim 9, wherein one of the plurality of smart devices is a computing device running a CE operating system, a computing device running a Pocket PC operating system, a computing device running a Palm operating system, a computing device running a Windows operating system, or a computing device running embedded programming systems and capable of communicating using standard protocols.

16. The system of claim 9, wherein the at least one controlled device is a lighting fixture, home appliance, fan, shade, garage door opener, controller for a heating system, controller for a cooling system, television, digital video disk player, compact disk player, stereo receiver, alarm system, security system, lock system, or sprinkler system.

17. A computer-readable medium containing instructions, executed by a processor for performing the method of routing command data through a system including a plurality of smart devices and at least one controlled device, the method including:
generating a command to remotely control a controlled device;
determining possible routes for transmitting the command by considering the communication capabilities of all devices in the system;
selecting a route based upon the determined possible routes; and
transmitting the command based upon the selected route.

18. The computer-readable medium of claim 17, wherein the command is transmitted using a plurality of protocols.

19. The computer-readable medium of claim 18, wherein the protocols are not interdependent.

20. The computer-readable medium of claim 17, wherein transmitting the command includes
transmitting the command to a smart device;
re-determining possible routes for transmitting the command by considering the communication capabilities of all devices in the system;
selecting a route based upon the determined possible routes; and
transmitting the command from the smart device based upon the selected route.

21. The computer-readable medium of claim 17, wherein the command is received or transmitted using at least one of wired IP, wireless IP, Bluetooth, serial communication, CEBus, and IRDA protocols.

22. The computer-readable medium of claim 17, wherein the command data includes at least one of Consumer IR, X10, HTTP, and S-Link data.

23. The computer-readable medium of claim 17, wherein one of the plurality of smart devices is a computing device running a CE operating system, a computing device running a Pocket PC operating system, a computing device running a Palm operating system, a computing device running a Windows operating system, or a computing device running embedded programming systems and capable of communicating using standard protocols.

24. The computer-readable medium of claim 17, wherein the at least one controlled device is a lighting fixture, home appliance, fan, shade, garage door opener, controller for a heating system, controller for a cooling system, television, digital video disk player, compact disk player, stereo receiver, alarm system, security system, lock system, or sprinkler system.

25. A method for routing command data through a system including a plurality of smart devices and at least one controlled device, the method including:
receiving a command to remotely control a controlled device;
determining whether the command should be directly utilized by the controlled device;
controlling the controlled device when it is determined the command should be directly utilized by the controlled device; and
transmitting the command when it is determined the command should not be directly utilized.

26. The method of claim 25, wherein the method further includes:
receiving the command using a first protocol; and
transmitting the command using a second protocol where the second protocol is different from the first.

27. The method of claim 26, wherein the protocols are not interdependent.

28. The method of claim 25, wherein the command is received or transmitted using at least one of wired IP, wireless IP, Bluetooth, serial communication, CEBus, and IRDA protocols.

29. The method of claim 25, wherein the command data includes at least one of Consumer IR, X10, HTTP, and S-Link data.

30. The method of claim 25, wherein one of the plurality of smart devices is a computing device running a CE operating system, a computing device running a Pocket PC operating system, a computing device running a Palm operating system, a computing device running a Windows operating system, or a computing device running embedded programming systems and capable of communicating using standard protocols.

31. The method of claim 25, wherein the at least one controlled device is a lighting fixture, home appliance, fan, shade, garage door opener, controller for a heating system, controller for a cooling system, television, digital video disk player, compact disk player, stereo receiver, alarm system, security system, lock system, or sprinkler system.

32. The method of claim 26, wherein transmitting the command includes
transmitting the command to a smart device;
re-determining possible routes for transmitting the command by considering the communication capabilities of all devices in the system;
selecting a route based upon the determined possible routes; and transmitting the command from the smart device based upon the selected route.

33. An apparatus for routing command data through a system including a plurality of smart devices and at least one controlled device, the apparatus comprising:
a receiver for receiving a command to remotely control a controlled device;
a first controller for determining whether the command should be directly utilized by the controlled device;
a second controller for controlling the controlled device when it is determined the command should be directly utilized by the controlled device; and
a transmitter for transmitting the command when it is determined the command should not be directly utilized.

34. The apparatus of claim 33, wherein the receiver receives the command using a first protocol and the transmitter transmits the command using a second protocol where the second protocol is different from the first.

35. The apparatus of 33, wherein the protocols are not interdependent.

36. The apparatus of claim 33, wherein the command is received or transmitted using at least one of wired IP, wireless IP, Bluetooth, serial communication, CEBus, and IRDA protocols.

37. The apparatus of claim 333, wherein the command data includes at least one of Consumer IR, X10, HTTP, and S-Link data.

38. The apparatus of claim 33, wherein one of the plurality of smart devices is a computing device running a CE operating system, a computing device running a Pocket PC operating system, a computing device running a Palm operating system, a computing device running a Windows operating system, or a computing device running embedded programming systems and capable of communicating using standard protocols.

39. The apparatus of claim 33, wherein the at least one controlled device is a lighting fixture, home appliance, fan, shade, garage door opener, controller for a heating system, controller for a cooling system, television, digital video disk player, compact disk player, stereo receiver, alarm system, security system, lock system, or sprinkler system.

40. A computer-readable medium containing instructions, executed by a processor for performing the method of routing command data through a system including a plurality of smart devices and at least one controlled device, the method including:
receiving a command to remotely control a controlled device;
determining whether the command should be directly utilized by the controlled device;
controlling the controlled device when it is determined the command should be directly utilized by the controlled device; and
transmitting the command when it is determined the command should not be directly utilized.

41. The computer-readable medium of claim 40, wherein the method further includes:
receiving the command using a first protocol; and
transmitting the command using a second protocol where the second protocol is different from the first.

42. The computer-readable medium of claim 41, wherein the protocols are not interdependent.

43. The computer-readable medium of claim 40, wherein the command is received or transmitted using at least one of wired IP, wireless IP, Bluetooth, serial communication, CEBus, and IRDA protocols.

44. The computer-readable medium of claim 40, wherein the command data includes at least one of Consumer IR, X10, HTTP, and S-Link data.

45. The computer-readable medium of claim 40, wherein one of the plurality of smart devices is a computing device running a CE operating system, a computing device running a Pocket PC operating system, a computing device running a Palm operating system, a computing device running a Windows operating system, or a computing device running embedded programming systems and capable of communicating using standard protocols.

46. The computer-readable medium of claim 40, wherein the at least one controlled device is a lighting fixture, home appliance, fan, shade, garage door opener, controller for a heating system, controller for a cooling system, television, digital video disk player, compact disk player, stereo receiver, alarm system, security system, lock system, or sprinkler system.

47. A method for automatically operating controlled devices in a system, the method including:
providing for a portable device and at least one stationary device;
determining the portable device is within predetermined proximity of the at least one stationary device;
controlling the at least one stationary device based upon the determination.

48. An system for automatically operating controlled devices in a system, the apparatus including:
a portable device and at least one stationary device; wherein the portable device includes
a determining module for determining the portable device is within predetermined proximity of the at least one stationary device; and
a controller for controlling the at least one stationary device based upon the determination.
